(19) United States
(12) Patent Application Publication
(10) Pub. No.: US 2020/0160663 A1
(43) Pub. Date: May 21, 2020

(54) GAMING DEVICES AND METHODS FOR ENHANCING PAYOUTS THROUGH AGGREGATION OF AWARD CONSTITUENTS

(71) Applicant: KING SHOW GAMES, INC., Minnetonka, MN (US)

(72) Inventor: Bradley BERMAN, Minnetonka, MN (US)

(21) Appl. No.: 16/683,988

(22) Filed: Nov. 14, 2019

Related U.S. Application Data
(60) Provisional application No. 62/768,545, filed on Nov. 16, 2018.

(51) Int. Cl. G07F 17/32

(52) U.S. Cl. CPC G07F 17/3267; G07F 17/3293; G07F 17/3211; G07F 17/3262; G07F 17/3244

(57) ABSTRACT

Systems, apparatuses and methods for providing aggregable game items in addition to cards over a series of poker games, and providing a benefit to the player based on the aggregated items. In an electronic poker embodiment, cards are dealt to single-hand or multiple-hand poker games, where the cards serve as the indicia that enables games to be conducted. In connection with participating in the series of poker games, game items may be randomly presented or otherwise referenced, and the collection of these game items over the series of poker games leads to awards, award/payout modifiers, game odds and/or payout enrichment, or the like.

### FIELD

This disclosure relates generally to games, and more particularly to systems, apparatuses and methods for enhancing payouts in gaming activities.

### BACKGROUND

Casino games such as poker, slots, and craps have long been enjoyed as a means of entertainment. Some of these games originated using traditional elements such as playing cards or dice. More recently, gaming devices have been developed to simulate and/or further enhance these games while remaining entertaining. The popularity of casino gambling with wagering continues to increase, as does recreational gambling such as non-wagering computer game gambling. Part of this popularity is due to the increased development of new types of games that are implemented, at least in part, on gaming devices.

One reason that casino games are widely developed for gaming devices is that a wide variety of games can be implemented on gaming devices, thereby providing an array of choices for players looking to gamble. For example, the graphics and sounds included in such games can be modified to reflect popular subjects, such as movies and television shows. Game play rules and types of games can also vary greatly providing many different styles of gambling. Additionally, gaming devices require minimal supervision to operate on a casino floor, or in other gambling environments. That is, as compared to traditional casino games that require a dealer, banker, stickman, pit managers, etc., gaming devices need much less employee attention to operate.

With the ability to provide new content, players have come to expect the availability of an ever wider selection of new games when visiting casinos and other gaming venues. Playing new games adds to the excitement of “gaming.” As is well known in the art and as used herein, the term “gaming” and “gaming devices” generally involves some form of wagering, and that players make wagers of value, whether actual currency or something else of value, e.g., token or credit. Wagering-type games usually provide rewards based on random chance as opposed to skill, although some skill may be an element in some types of games. Since random chance is a significant component of these games, they are sometimes referred to as “games of chance.”

The present disclosure describes systems, apparatuses and methods that facilitate new and interesting gaming experiences, and provide advantages over the prior art.

### SUMMARY

The present disclosure is directed to systems, apparatuses, computer-readable media, and/or methods that are configured to enhance payouts through aggregation of award constituents spanning multiple gaming events.

Generally, systems, apparatuses and methods are disclosed for increasing or otherwise enhancing acquired payouts by collecting randomly granted award constituents over the course of multiple gaming events. When the award constituents have been collected such that a threshold is met, a benefit is awarded to the player, such as providing a payout modifier, game play item enrichment, direct award, etc.

In one embodiment, a gaming apparatus is provided for facilitating player participation in poker games. The gaming apparatus includes a display, a user interface configured to receive at least player input to facilitate player participation in the poker games, a wager input device structured to identify and validate player assets and to permit the player to participate in the poker games in which the player assets are provided, and a processor. The processor is configured to randomly select cards to present in each of a sequence of the poker games, and randomly present game items in connection with any of the poker games of the sequence. The processor is configured to track an aggregation of the game items randomly presented during the player participation in the sequence of poker games, and to monitor for a game item termination event during the poker games. In response to the game item termination event occurring in connection with a currently-played one of the sequence of poker games, the processor determines an award based on the tracked aggregation of the game items, and provides the determined award for use with at least one of the poker games.

In accordance with a more particular embodiment of such a gaming apparatus, the processor is configured to determine the award based on the tracked aggregation of the game items by determining a quantity of the game items that were presented during the player participation in the sequence of the poker games, and providing a Wild card for each of the determined quantity of the game items for use with the at least one of the poker games. In a more particular embodiment, the processor is configured to provide the determined award for use with at least one of the poker games by providing the award for use with the currently-played poker game, and randomly distributing any of the provided Wild cards to card positions of the currently-played poker game. In another particular embodiment, the processor is configured to provide the determined award for use with at least one of the poker games by providing the determined award for use with the next consecutive poker game following the sequence of poker games, and randomly distributing any of the provided Wild cards to card positions of the next consecutive poker game following the sequence of poker games.

According to another embodiment of such a gaming apparatus, the processor is configured to determine the award based on the tracked aggregation of the game items by determining how many game items were presented during the played sequence of the poker games, and providing a payout multiplier having a multiplication quantity based on the quantity of the game items for use with the at least one of the poker games.

In another embodiment, the processor of such gaming apparatus is configured to determine the award based on the tracked aggregation of the game items by identifying multiplier values on one or more of the tracked aggregation of the game items, and providing a payout multiplier having a multiplication quantity based on a collective value of the identified multiplier values.

According to another embodiment of such a gaming apparatus, the processor is configured to monitor for the game item termination event by monitoring for completion of the player participation in a threshold number of the poker games constituting the sequence of the poker games. In another embodiment, the processor is configured to monitor for the game item termination event by monitoring for a threshold number of the game items being collected.

In one embodiment of such a gaming apparatus, the processor is configured to provide the award for use with at least one of the poker games by providing the award for use with the currently-played poker game. In another embodiment, the processor is configured to provide the award for use with at least one of the poker games by providing the award for use with the next consecutive poker game following the sequence of poker games. In still another embodiment, the processor is configured to provide the determined award for use with at least one of the poker games by providing the determined award for use with one or more subsequent poker game following the sequence of poker games. In cases where the award is provided for a poker game following the sequence of poker games, some embodiments also allow the award to be provided for the currently-played poker game.

In accordance with another embodiment of such a gaming apparatus, the processor is configured to present the tracked aggregation of the game items to enable the player to perceive progress of the tracked aggregation of the game items.

In another embodiment, the processor is configured to randomly present the game items by randomly displaying, via the display, sub-symbols in connection with the randomly selected cards of the sequence of the poker games.

In another embodiment of such a gaming apparatus, the processor is configured to facilitate the player's participation in a plurality of the sequences of the poker games, and to provide respective ones of the determined awards on each of the plurality of the sequences of the poker games.

In another embodiment, a gaming apparatus is provided for facilitating player participation in poker games. The gaming apparatus includes a display, a user interface configured to receive at least player input to facilitate player participation in the poker games, a wager input device structured to identify and validate player assets and to permit the player to participate in the poker games in which the player assets are provided, and a processor. The processor is configured to randomly select cards to present in each of a plurality of the poker games, and randomly present game items in connection with any of the poker games. The processor is configured to track an aggregation of the game items randomly presented during the player participation in the poker games, and monitor for a threshold quantity of the poker games having been played. In response to the threshold quantity of the poker games having been played, the processor is configured to determine a quantity of the game items that have been aggregated, provide one or more Wild cards based on the determined quantity of the game items that have been aggregated, and provide the one or more Wild cards for use in the poker game in which the threshold quantity of the poker games has been reached. In other embodiments, the one or more Wild cards may instead or additionally be used on one or more poker games subsequent to the poker game in which the threshold quantity of the poker games has been reached.

In another embodiment of such a gaming apparatus, the processor is configured to provide the one or more Wild cards by providing one of the Wild cards for each of the determined quantity of the game items that have been aggregated.

In another embodiment, the processor is further configured to provide one or more payout modifiers for use in the poker game in which the threshold quantity of the poker games has been reached, in response to the threshold quantity of the poker games having been played.

In accordance with another embodiment, a gaming apparatus is provided for facilitating player participation in poker games. The gaming apparatus includes a display, a user interface configured to receive at least player input to facilitate player participation in the poker games, a wager input device structured to identify and validate player assets and to permit the player to participate in the poker games in which the player assets are provided, and a processor. The processor is configured to randomly select cards to present in each of a plurality of the poker games, and randomly present game items in connection with any of the poker games. The processor is configured to track an aggregation of the game items randomly presented during the player participation in the poker games, and monitor for a threshold quantity of the poker games having been played. In response to the threshold quantity of the poker games having been played, the processor is configured to determine a quantity of the game items that have been aggregated, provide one or more payout modifiers based on the determined quantity of the game items that have been aggregated, and provide the one or more payout modifiers for use in the poker game in which the threshold quantity of the poker games has been reached. In other embodiments, the one or more payout modifiers may instead or additionally be used on one or more poker games subsequent to the poker game in which the threshold quantity of the poker games has been reached.

In accordance with another embodiment of such a gaming apparatus, the processor is configured to provide the one or more payout modifiers by providing a multiplier having a multiplier value equivalent to the determined quantity of the game items that have been aggregated.

According to yet another embodiment of such a gaming apparatus, the processor is further configured to provide one or more Wild cards for use in the poker game in which the threshold quantity of the poker games has been reached, in response to the threshold quantity of the poker games having been played.

This summary serves as an abbreviated, selective introduction of a representative subset of various concepts and embodiments that are further described or taught to those skilled in the art in the Specification herein. This summary is not intended to refer to all embodiments, scopes, or breadths of claims otherwise supported by the Specification, nor to identify essential features of the claimed subject matter, nor to limit the scope of the claimed subject matter.

### BRIEF DESCRIPTION OF THE DRAWINGS

FIG. 1 is a diagram of a representative gaming machine capable of facilitating player use and interaction with games and features in accordance with the invention and representative embodiments described herein.

FIG. 2 is a block diagram illustrating a representative computing arrangement capable of implementing games and features in accordance with the invention and representative embodiments described herein.

FIGS. 3A and 3B depict representative examples of gaming activities where award constituents are collected over a series of gaming events, and a player benefit is provided based on the collected award constituents and the occurrence of a triggering event.

FIG. 4 depicts a representative video poker embodiment, where game items are aggregated over a series of played poker hands to provide a player benefit upon reaching a threshold.

FIG. 5 depicts a representative example of a multi-hand draw poker game employing the player award features described herein.

FIGS. 6A and 6B are diagrams of representative electronic poker devices for enhancing payments or otherwise providing awards for electronic poker games based on a collection of game play items.

### DETAILED DESCRIPTION

In the following description of various exemplary embodiments, reference is made to the accompanying drawings which form a part hereof, and in which is shown by way of illustration representative embodiments in which the features described herein may be practiced. It is to be understood that other embodiments may be utilized, as structural and operational changes may be made without departing from the scope of the disclosure.

In the description that follows, the terms “reels,” “cards,” “decks,” and similar mechanically descriptive language may be used to describe various apparatus presentation features, as well as various actions occurring to those objects (e.g., “spin,” “draw,” “hold,” “bet”). Although the present disclosure may be applicable to manual, mechanical, and/or computerized embodiments, as well as any combination therebetween, the use of mechanically descriptive terms is not meant to be only applicable to mechanical embodiments. Those skilled in the art will understand that, for purposes of providing gaming experiences to players, mechanical elements such as cards, reels, and the like may be simulated on a display in order to provide a familiar and satisfying experience that emulates the behavior of mechanical objects, as well as emulating actions that occur in the non-computerized games (e.g., spinning, holding, drawing, betting). Further, the computerized version may provide the look of mechanical equivalents but may be generally randomized in a different way. Thus, the terms “cards,” “decks,” “reels,” “hands,” etc., are intended to describe both physical objects and emulation or simulations of those objects and their behaviors using electronic apparatuses.

In various embodiments, the gaming displays are described in conjunction with the use of data in the form of “symbols.” In the context of this disclosure, a “symbol” may generally refer at least to a collection of one or more arbitrary indicia or signs that have some conventional or defined significance. In particular, the symbol may represent values that can at least be used to determine whether to award a payout. A symbol may include numbers, letters, shapes, pictures, textures, colors, sounds, etc., and any combination therebetween. A play state, such as a win, can be determined by comparing the symbol with one or more other symbols. Such comparisons can be performed, for example, via software by mapping numbers (or other data structures such as character strings) to the symbols and performing the comparisons on the numbers/data structures. Other conventions associated with known games (e.g., the numerical value/ordering of face cards and aces in card games) may also be programmatically analyzed to determine winning combinations.

Generally, systems, apparatuses and methods are disclosed for increasing or otherwise enhancing acquired payouts by collecting randomly granted award constituents over the course of multiple gaming events. When the award constituents have been collected such that a threshold is met, a benefit is awarded to the player, such as providing a payout modifier, game play item enrichment, direct award, etc. The systems, apparatuses and methods described herein may be implemented as a single game, or part of a multi-part game. For example, the game features described herein may be implemented in primary gaming activities, bonus games, side bet games or other secondary games associated with a primary gaming activity. The game features may be implemented in stand-alone games, multi-player games, etc. Further, the disclosure may be applied to games of chance, and descriptions provided in the context of any representative game (e.g. poker, such as video poker) is provided for purposes of facilitating an understanding of the features described herein. However, the principles described herein are equally applicable to any game of chance where an outcome(s) is determined for use in the player's gaming activity.

Embodiments of the present concept include providing gaming devices (also referred to as gaming apparatuses or gaming machines), gaming systems, and methods of operating these devices or systems to provide game play that involves granting aggregable items over a series of gaming events, and providing a gaming benefit to the player based on the aggregated items.

In one embodiment, the gaming activity comprises a card game, which may involve a single hand of cards or multiple hands of cards. The cards serve as the indicia that enables games to be conducted, through interaction of the card indicia. In connection with participating in the card game over a series of card game events (e.g., poker hands), items may be presented or otherwise referenced, and the collection of these items over the series of card game events leads to an award, award/payout modifier, game odds and/or payout enrichment, or the like.

These principles may be applied in a poker context, regardless of the type of poker game. The poker game may involve stud poker variations, draw poker variations, community card poker variations, any combination thereof, or any other wagering game utilizing cards. In one embodiment, one or more cards of a hand(s) in a single or multiple hand game may be randomly or systematically marked, and the markings are monitored to provide an award or award modifier when some triggering event occurs.

Numerous variations are possible in view of these and other embodiments of the inventive concept. Representative embodiments and variations are described herein, with some embodiments described with reference to the drawings. However, many other embodiments and variations exist that are covered by the principles and scope of this concept. For example, although some of the embodiments discussed below involve electronic/video poker examples of this concept, other embodiments include application of these inventive techniques in of slot games, other card games, roulette, bingo, or other games of chance. Some of these other types of embodiments will be discussed below as variations to the examples illustrated. However, many other types of games can implement similar techniques and fall within the scope of this disclosed concept.

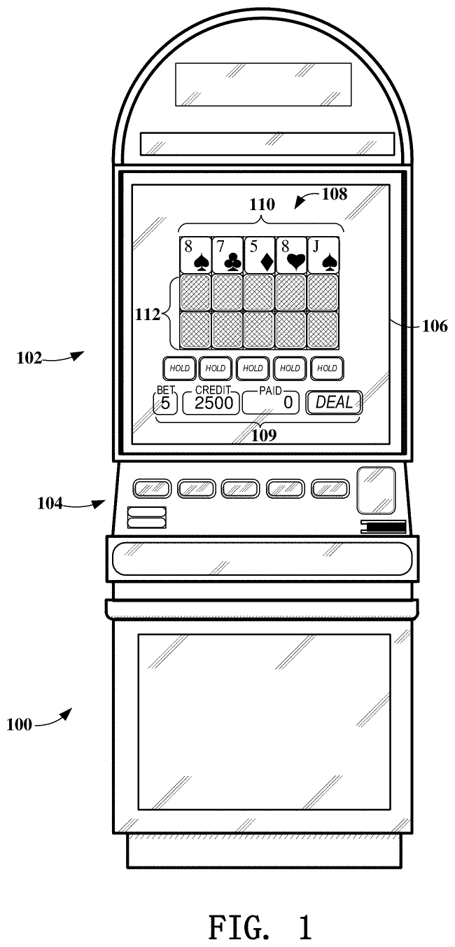

Referring to the example gaming apparatus 100 shown in FIG. 1, the representative gaming apparatus includes at least a display area(s) 102 (also referred to as a gaming display), and a player interface area(s) 104, although some or all of the interactive mechanisms included in the user interface area 104 may be provided via other or additional means, such as graphical icons used with a touch screen in the display area 102 in some embodiments. The display area 102 may include one or more game displays 106 (also referred to as “displays” or “gaming displays”) that may be included in physically separate displays or as portions of a common large display. Here, the representative game display 106 includes at least a primary game play portion 108 that displays game elements and symbols 110, and an operations portion 109 that can include meters, various game buttons and other input mechanisms, and/or other game information for a player of the gaming device 100.

The user interface 104 allows the user to control, engage in play of, and otherwise interact with the gaming machine 100. The particular user interface mechanisms included with user interface 104 may be dependent on the type of gaming device. For example, the user interface 104 may include one or more buttons, switches, joysticks, levers, pull-down handles, trackballs, voice-activated input, touchscreen input, tactile input, and/or any other user input system or mechanism that allows the user to play and interact with the particular gaming activity.

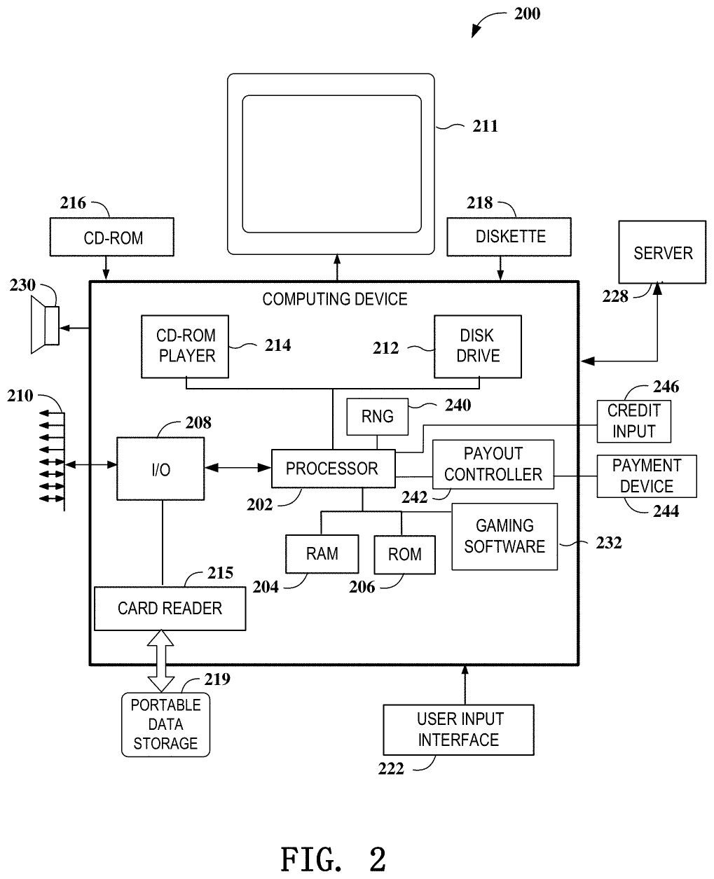

The user interface 104 may allow the user or player to enter coins, bills, or otherwise obtain credits through vouchers, tokens, credit cards, tickets, electronic money, etc. Various mechanisms for entering such vouchers, tokens, credit cards, coins, tickets, etc. are described below with reference to FIG. 2. For example, currency input mechanisms, card readers, credit card readers, smart card readers, punch card readers, radio frequency identifier (RFID) readers, and other mechanisms may be used to enter wagers. The user interface 104 may also include a mechanism to read and/or validate player information, such as player loyalty information to identify a user or player of the gaming device. This mechanism may be, for example, a card reader, biometric scanner, keypad, or other input device. It is through a user interface such as the user interface 104 that the player can initiate and engage in gaming activities. While the illustrated embodiment depicts various buttons for the user interface 104, it should be recognized that a wide variety of user interface options are available for use in connection with the present invention, including pressing buttons, touching a segment of a touch-screen, entering text, entering voice commands, or other known data entry methodology.

The game display 106 in the display area 102 may include one or more of an electronic display, a video display, a mechanical display, and fixed display information, such as pay table information associated with a glass/plastic panel(s) on the gaming machine 100 and/or graphical images. The symbols or other indicia associated with the play of the game may be presented on an electronic display device or on mechanical devices associated with a mechanical display. Generally, in some embodiments, the display 106 devotes the largest portion of viewable area to the primary gaming portion 108. The primary gaming portion 108 may provide visual feedback to the user for any selected game. The primary gaming portion 108 may render graphical objects such as cards, slot reels, dice, animated characters, and any other gaming visual known in the art. The primary gaming portion 108 may also inform players of the outcome of any particular event, including whether the event resulted in a win or loss.

In some embodiments described herein, the primary gaming portion 108 may display a grid(s) or equivalent arrangement(s) of playing cards 110 forming one or more hands or other sets of cards in a card game, such as a poker game. In the illustrated example, a set of five playing cards 110 forms a video poker hand, which represents a portion of a game play event. For example, if the game play event is a video draw poker game, the gaming device 100 may deal five cards, allow the user to select cards to hold, deal replacements for the cards not held, and determine a payout based on the final cards in the hand. The illustration and description of five-card draw poker is for purposes of example and not of limitation, as the disclosure is applicable to numerous other card games, such as stud poker or hold 'em poker, as well as other types of gaming activities and apparatuses, such as slot machines, dice, coins, etc. For example, some embodiments may relate to slot games, where the primary gaming portion 108 presents a grid (or equivalent arrangement) of symbols or other game elements in respective symbol locations (not shown), where the symbols or combinations of symbols determine gaming outcomes.

In some embodiments, the primary gaming portion 108 may also display one or more additional hands 112 of playing cards, such as in a multi-play poker embodiment. For example, one multi-play poker embodiment involves draw poker, where at least one hand 110 is dealt, and cards held by the player in hand 110 are replicated into one or more other hands 112, whereby all hands 110, 112 may then be completed with replacement cards while having one or more commonly held cards. Multi-play embodiments may also be played without holding any cards, and/or without replication of held cards into other hands. In some embodiments, other hands 112 may represent discrete, individually-played additional hands of cards that are unrelated to the play of other hands 110.

The primary gaming portion 108 may include other features known in the art that facilitate gaming, such as status and control portion 109. As is generally known in the art, this portion 109 provides information about current bets, current wins, remaining credits, etc. associated with gaming activities of the grid of game elements 110. The control portion 109 may also provide touchscreen controls for facilitating game play. The grid of game elements 110 may also include touchscreen features, such as facilitating selection of individual cards to hold and/or selection of individual cards to discard and replace (e.g., in a draw poker embodiment), which subset of cards of a larger set of cards to hold/use for a final hand(s) (e.g., in some stud poker embodiments), wagering inputs, etc. The game display 106 of the display area 102 may include other features that are not shown, such as pay tables, navigation controls, etc.

Although FIG. 1 illustrates a particular implementation of some of the embodiments in a casino or electronic gaming machine (“EGM”), one or more devices may be programmed to play various embodiments of the disclosure. The concepts and embodiments described herein may be implemented, as shown in FIG. 1, as an electronic/video gaming machine or other special purpose gaming kiosk, or may be implemented via computing systems operating under the direction of local gaming software, and/or remotely-provided software such as provided by an application service provider (ASP). Such gaming machines may also utilize computing systems to control and manage the gaming activity, although these computing systems typically include specialized components and/or functionality to operate the particular elements of electronic gaming machines. Additionally, computing systems operating over networks, such as the Internet, may also include specialized components and/or functionality to operate elements particular to these systems, such as random number generators. An example of a representative computing system capable of carrying out operations in accordance with the principles described herein is illustrated in FIG. 2.

Hardware, firmware, software or any combination thereof may be used to perform the various gaming functions, display presentations and operations described herein. The functional modules used in connection with the disclosure may reside in a gaming machine as described, or may alternatively reside on a stand-alone or networked computer. The representative computing structure 200 of FIG. 2 is an example of a computing structure that can be used in connection with such electronic gaming machines, computers, or other computer-implemented devices to carry out operations of the present invention. Although numerous components or elements are shown as part of this computing structure 200 in FIG. 2, additional or fewer components may be utilized in particular implementations of embodiments of the invention.

The example computing arrangement 200 suitable for performing the gaming functions described herein includes a processor(s), such as depicted by the representative central processing unit (CPU) 202, coupled to memory, such as random access memory (RAM) 204, and some variation of read-only memory (ROM) 206 or other persistent storage. The ROM 206 may also represent other types of storage media to store programs, such as programmable ROM (PROM), erasable PROM (EPROM or any technology capable of storing data). The processor 202 may communicate with other internal and external components through input/output (I/O) circuitry 208 and bussing 210, to communicate control signals, communication signals, and the like.

The computing arrangement 200 may also include one or more data storage devices, including hard and floppy disk drives 212, CD-ROM drives 214, card reader 215, and other hardware capable of reading and/or storing information such as DVD, etc. In one embodiment, software for carrying out the operations in accordance with the present invention may be stored and distributed on a CD-ROM 216, diskette 218, access card 219, or other form of computer readable media capable of portably storing information. These storage media may be inserted into, and read by, devices such as the CD-ROM drive 214, the disk drive 212, card reader 215, etc. The software may also be transmitted to the computing arrangement 200 via data signals, such as being downloaded electronically via a network, such as local area network (casino, property, or bank network) or a wide area network (e.g., the Internet). Further, as previously described, the software for carrying out the functions associated with the present invention may alternatively be stored in internal memory/storage of the computing device 200, such as in the ROM 206.

The computing arrangement 200 is coupled to one or more displays 211, which represent a manner in which the gaming activities may be presented. The display 211 represents the “presentation” of the game information in accordance with the disclosure, and may be a mechanical display, or an electronic/video display such as liquid crystal displays, plasma displays, cathode ray tubes (CRT), digital light processing (DLP) displays, liquid crystal on silicon (LCOS) displays, etc., or any type of known display or presentation screen.

Where the computing device 200 represents a stand-alone or networked computer, the display 211 may represent a standard computer terminal or display capable of displaying multiple windows, frames, etc. Where the computing device 200 represents a mobile electronic device, the display 211 may represent the video display of the mobile electronic device. Where the computing device 200 is embedded within an electronic gaming machine, the display 211 corresponds to the display screen of the gaming machine/kiosk.

A user input interface 222 such as a mouse, keyboard/keypad, microphone, touch pad, trackball, joystick, touch screen, voice-recognition system, card reader, biometric scanner, RFID detector, etc. may be provided. The user input interface 222 may be used to input commands in the computing arrangement 200, such as placing wagers or initiating gaming events on the computing arrangement 200, inputting currency or other payment information to establish a credit amount or wager amount, inputting data to identify a player for a player loyalty system, etc. The display 211 may also act as a user input device, e.g., where the display 211 is a touchscreen device. In embodiments, where the computing device 200 is implemented in a personal computer, tablet, smart phone, or other consumer electronic device, the user interface and display may be the available input/output mechanisms related to those devices.

Chance-based gaming systems such as slot machines, in which the present invention is applicable, are governed by random numbers and processors, as facilitated by a random number generator (RNG) or other random generator. The fixed and dynamic symbols generated as part of a gaming activity may be produced using one or more RNGs. RNGs may be implemented using hardware, software operable in connection with the processor 202, or some combination of hardware and software. The principles described herein are operable using any known RNG, and may be integrally programmed as part of the processor 202 operation, or alternatively may be a separate RNG controller 240 that may be associated with the computing arrangement 200 or otherwise accessible such as via a network. The RNGs are often protected by one or more security measures to prevent tampering, such as by using secured circuitry, locks on the physical game cabinet, and/or remote circuitry that transmits data to the gaming device.

The computing arrangement 200 may be connected to other computing devices or gaming machines, such as via a network. The computing arrangement 200 may be connected to a network server(s) 228 in an intranet or local network configuration. The computer may further be part of a larger network configuration as in a global area network (GAN) such as the Internet. In such a case, the computer may have access to one or more web servers via the Internet. In other arrangements, the computing arrangement 200 may be configured as an Internet server and software for carrying out the operations in accordance with the present invention may interact with the player via one or more networks. The computing arrangement 200 may also be operable over a social network or other network environment that may or may not regulate the wagering and/or gaming activity associated with gaming events played on the computing arrangement.

Other components directed to gaming machine implementations include manners of gaming participant payment, and gaming machine payout. For example, a gaming machine including the computing arrangement 200 may also include a payout controller 242 to receive a signal from the processor 202 or other processor(s) indicating a payout is to made to a player and controlling a payout device 244 to facilitate payment of the payout to the player. In some embodiments, the payout controller 242 may independently determine the amount of payout to be provided to the participant or player. In other embodiments, the payout controller 242 may be integrally implemented with the processor 202. The payout controller 242 may be a hopper controller, a print driver, credit-transmitting device, bill-dispensing controller, accounting software, or other controller device configured to verify and/or facilitate payment to a player.

A payout or payment device 244 may also be provided in gaming machine embodiments, where the payment device 244 serves as the mechanism providing the payout to the player or participant. In some embodiments, the payment device 244 may be a hopper, where the hopper serves as the mechanism holding the coins/tokens of the machine, and/or distributing the coins/tokens to the player in response to a signal from the payout controller 242. In other embodiments, the payout device 244 may be a printer mechanism structured to print credit-based tickets that may be redeemed by the player for cash, credit, or other casino value-based currency or asset. In yet other embodiments, the payout device 244 may send a signal via the network server 228 or other device to electronically provide a credit amount to an account associated with the player, such as a credit card account or player loyalty account. The computing arrangement 200 may also include accounting data stored in, for example, one of the memory devices 204, 206. This accounting data may be transmitted to a casino accounting network or other network to manage accounting statistics for the computing arrangement or to provide verification data for the currency or currency-based tickets distributed by the payout device, such as providing the data associated with the bar codes printed on the currency-based tickets so they are identifiable as valid tickets for a particular amount when the player redeems them or inserts them in another gaming device.

The wager input module or device 246 represents any mechanism for accepting coins, tokens, coupons, bills, electronic fund transfer (EFT), tickets, credit cards, smart cards, membership/loyalty cards, or any other player assets, for which a participant inputs a wager amount. The wager input device 246 may include magnetic strip readers, bar code scanners, light sensors, or other detection devices to identify and validate physical currency, currency-based tickets, cards with magnetized-strips, or other medium inputted into the wager input device. When a particular medium is received in the wager input device 246, a signal may be generated to establish or increase an available credit amount or balance stored in the internal memory/storage of the computing device 200, such as in the RAM 204. Thereafter, specific wagers placed on games may reduce the available credit amount, while awards won may increase the available credit amount. It will be appreciated that the primary gaming software 232 may be able to control payouts via the payment device 244 and payout controller 242 for independently determined payout events.

Among other functions, the computing arrangement 200 provides an interactive experience to players via an input interface 222 and output devices, such as the display 211, speaker 230, etc. These experiences are generally controlled by gaming software 232 that controls a primary gaming activity of the computing arrangement 200. The gaming software 232 may be temporarily loaded into RAM 204, and may be stored locally using any combination of ROM 206, drives 212, media player 214, or other computer-readable storage media known in the art. The primary gaming software 232 may also be accessed remotely, such as via the server 228 or the Internet.

The primary gaming software 232 in the computing arrangement 200 may be an application software module. According to embodiments of the present invention, this software 232 provides a slot game or similar game of chance as described herein. For example, the software 232 may present, by way of the display 211, representations of symbols to map or otherwise display as part of a slot based game having reels. However, in other embodiments, the principles of this concept may be applied to poker games or other types of games of chance. One or more aligned positions of these game elements may be evaluated to determine awards based on a pay table. The software 232 may include instructions to provide other functionality as known in the art or as described and shown herein.

The systems, apparatuses and methods operable via these and analogous computing and gaming devices can support gaming features as described herein. Many embodiments may be described in terms of an electronic poker game, where presented cards potentially form a result(s) that conforms to a predetermined winning outcome to determine payout awards. However, the principles described herein are equally applicable to other games of chance, as described herein and as will be readily apparent to those skilled in the art from the teachings herein.

Generally, systems, apparatuses and methods are disclosed for increasing or otherwise enhancing acquired payouts to provide some player benefit or added player benefit. In one embodiment, the player benefits are direct awards or award modifiers, and are obtained by aggregating randomly presented items over a series of poker hands, and providing the award or modifier when a trigger condition is met. In one embodiment, the trigger condition is a number of the aggregated items reaching a static or dynamic threshold. In another embodiment, the trigger condition is a number of poker hands played, where the number of aggregated items acquired during that number of poker hands affects the actual value or potential value of the resulting award/award modifier. Video gaming embodiments may be implemented in a software/firmware-controlled processor (including single, multiple, distributed and/or other processing arrangements) where such processor-based software modules facilitate the payout enhancement (e.g., awards, award modifiers, game play enrichment, etc.) obtained through the inter-event aggregation of award constituents.

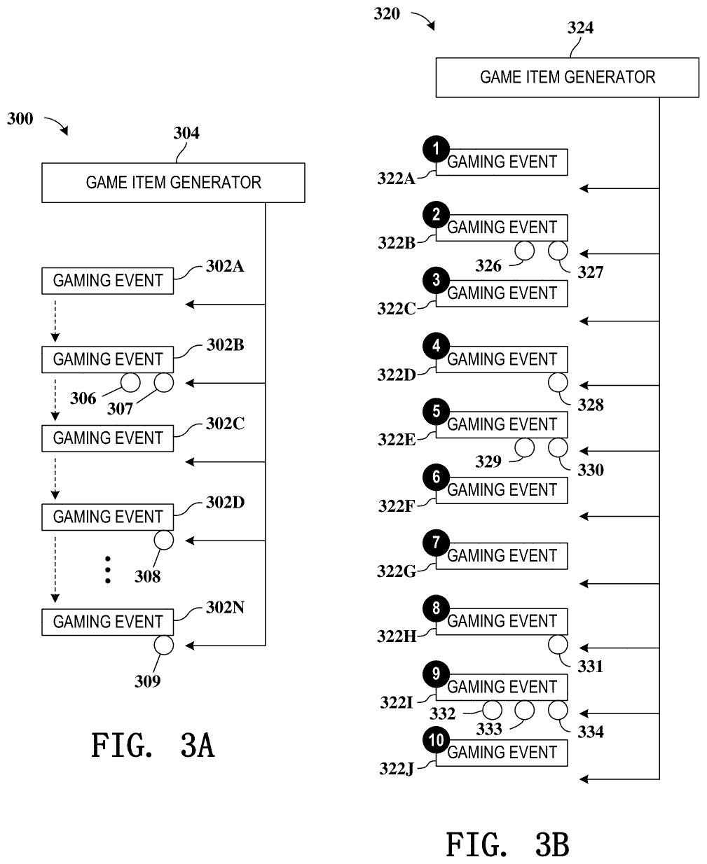

FIGS. 3A and 3B depict representative examples of gaming activities including multiple gaming events, where award constituents are collected over a series of the gaming events, and the player obtains an award, award modifier, and/or other player benefit based on the collected award constituents and the occurrence of a triggering event(s). FIG. 3A depicts a gaming activity 300, including a series of gaming events 302A, 302B, 302C, 302D up to some indeterminate number of gaming events 302N. The gaming events are hands of poker in one embodiment. As the gaming events are carried out, perceivable items may be provided, such as being randomly provided by a game item generator 304. The game item generator 304 may be implemented as a processor-based software module that utilizes a random number generator or other random event generator to randomly determine if, when, how many, etc. such game items to issue on each of the gaming events 302A-302N. In one embodiment, the game item generator 304 tracks the number of items issued, where in other embodiments the issued items may be counted or otherwise tracked by another module (not shown) as they are issued by the game item generator 304.

In the illustrated embodiment of FIG. 3A, the player participates in a first gaming event 302A. In this example, the game item generator 304 did not issue any of the aggregable game items. The player then participates in the next gaming event 302B, where game items 306 and 307 have been issued by the game item generator 304. At the next gaming event 302C, no game items were generated, and at gaming event 302D one game item 308 was issued.

This may continue until a triggering event occurs. In the example of FIG. 3A, it is assumed that the triggering event is quantity-based, such that when the number of game items 306, 307, 308, 309 that are issued reaches a threshold number, threshold range, etc., the player is provided with a player benefit, such as an award (e.g., credit/money award), award modifier (e.g., payout multiplier that is applied to a payout(s) otherwise occurring with the gaming event 302N or other payout), game play enrichment (e.g., being awarded additional cards in a poker game to increase the chances of obtaining a certain poker outcome(s)), etc.

For example, when some number of game items 306-309 have been issued, such as 10 game items, the player may receive a payout multiplier that may be fixed, randomly determined, based on wager input, or otherwise tied to some game play factors. Such a payout multiplier may be multiplied by the payout (if any) occurring in the gaming event 302N in which the trigger occurred. In other embodiments, the payout multiplier may be multiplied by other payouts, such as the next payout, other future payouts, all payouts occurring during the gaming events 302A-302N, other past payouts, a randomly-provided payout, etc.

Therefore, the example of FIG. 3A depicts a series of gaming events whereby game items are randomly issued during the course of play, and the aggregation of some number of such game items provides the player with a gaming benefit. In a video poker embodiment, FIG. 3A represents a series of poker events (e.g., single-hand poker events, multiple-hand poker events, etc.), where visual items such as coins are randomly displayed on cards associated with the respective gaming event 302A-302N, and when the number of issued coins reaches a threshold, the player is awarded with a multiplier. In one embodiment, every card may have a chance to receive one or more sub-symbols. In some embodiments, symbols or other indicia may be issued independently of the cards themselves, such as randomly presenting the game items 306-309 on a separate display, or on the gaming activity display but unassociated with particular cards, etc.

FIG. 3B depicts another representative gaming activity 320, including a series of gaming events 322A, 322B, 322C, 322D, 322E, 322F, 322G, 322H, 322I, 322J (collectively referred to as gaming events 322 or 322A-322J), which represents some string of consecutive gaming events of the gaming activity 320 played by the player. The gaming events are hands of poker in one embodiment. As the gaming events are carried out, perceivable items may be provided, such as being randomly provided by a game item generator 324. The game item generator 324 may be implemented as a processor-based software module that utilizes a random number generator or other random event generator to randomly determine if, when, how many, etc. such game items to issue on each of the gaming events 322A-322J. In the embodiment of FIG. 3B, the game item generator 324 tracks the number of items issued over a particular number of the gaming events 322A-322J, which in the present example is 10 gaming events.

In the illustrated embodiment of FIG. 3B, the player participates in a first gaming event 322A. In this example, the game item generator 324 did not issue any of the aggregable game items. The player then participates in the next gaming event 322B, where game items 326 and 327 have been issued by the game item generator 324. For the next eight gaming events 322C-322J, no game items were issued in connection with gaming events 322C, 322F, 322G and 322J, while game items 328, 329, 330, 331, 332, 333 and 334 were issued in connection with gaming events 322D, 322E, 322H, and 322I as depicted in FIG. 3B.

In the illustrated embodiment, the triggering event is defined to be a number of played gaming events, where the number may be fixed for the gaming activity 320, or may be randomly selected, or otherwise change over time. In the illustrated embodiment, it is assumed that the triggering event is defined to be participation in 10 consecutive gaming events, such as 10 poker events. Thus, when gaming event 322J is played, which is the tenth played gaming event in this example, the number of game items 326-334 are determined, whether tracked by the game item generator 324 as they are issued, or counted by another module (not shown) once they have been associated with a respective gaming event, etc.

With this threshold condition having been met, the player is provided with a player benefit, such as an award, award modifier, game play enrichment, etc. For example, in one representative embodiment, when ten poker hands 322A-322J have been played, the player may receive a payout multiplier that may be fixed, randomly determined, based on wager input, or otherwise tied to some game play factors. For example, the number of coins or other game items collected during the ten poker hands 322A-322J may correlate to the benefit, such as getting an 8× multiplier if eight coins/game items are collected, or getting a 50 credit award if five coins/game items are collected, etc. Such a payout multiplier may be multiplied by the payout (if any) occurring in the gaming event 302J in which the trigger occurred. In other embodiments, the payout multiplier may be multiplied by other payouts, such as the next payout, other future payouts, all payouts occurring during the gaming events 322A-322J, other past payouts, a randomly-provided payout, etc.

FIG. 3B depicts an example where the number of collected game items over some period determines, or at least contributes to, the benefit provided. The period over with the game items are collected in FIG. 3B is a count of games played, such as a count of consecutive poker games played. However, other periods may be analogously applied, whether a count of games played, a time elapsed, occurrence of a triggering event (e.g. a random symbol or other signal occurring; a particular card occurring; a particular poker result occurring; etc.), or other event that can serve as an aggregation termination condition.

Therefore, the example of FIG. 3B depicts a series of gaming events whereby game items are randomly issued during the course of play, and the aggregation of some number of such game items provides the player with a gaming benefit. In a video poker embodiment, FIG. 3B represents a series of poker events, where visual items such as coins are randomly displayed on cards associated with the respective gaming event 322A-322J, and when the number of gaming events played reaches a threshold (e.g., every ten hands played), the player is awarded with a multiplier. In one embodiment, every card may have a chance to receive one or more sub-symbols. In some embodiments, symbols or other indicia may be issued independently of the cards themselves, such as randomly presenting the game items 326-334 on a separate display, or on the gaming activity display but unassociated with particular cards, etc.

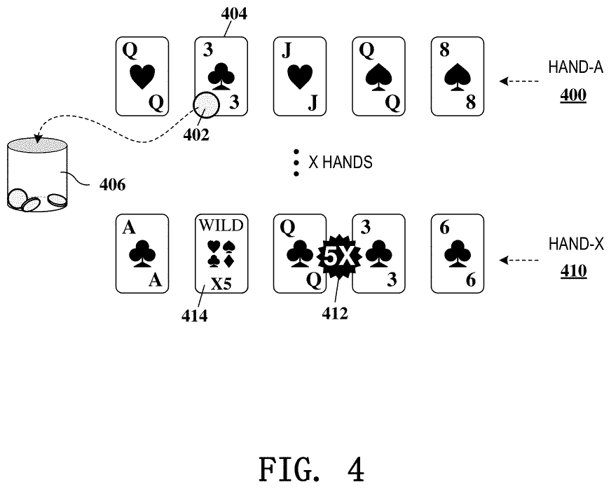

FIG. 4 depicts a representative video poker embodiment, where game items are collected over a series of played poker hands to provide a player benefit upon reaching a threshold. In this embodiment, the collectable game items are presented in connection with dealt and/or drawn cards, and may represent known items, such as coins that are collected in a coin pot/jar as they are awarded. These coins or other game items serve as award constituents, as they occur in parts over time until a triggering event occurs to provide an associated benefit to the player.

The principles described herein may be applied in any poker context, such as stud poker variations, draw poker variations, community card poker variations, any combination thereof, or any other wagering game utilizing cards. When associated with the cards, the “coins” or other game items may be provided in connection with initially dealt cards, drawn cards in draw poker embodiments, unused cards in stud poker, etc.

A first hand-A 400 of poker is dealt, which is assumed to be a single-hand, 5-card stud or draw poker game for purposes of this example. In this example, a game item, a “coin” 402 in this example, has been issued on one of the cards 404. The aggregable or collectable items, e.g., coin 402 and others that are issued, may be animated or otherwise visually collected, such as in the coin container 406 (e.g., a virtual container displayed on a display screen in some video poker embodiments). In one embodiment, every ten hands (or however many hands desired), the coins in the container 406 are used as the basis for providing an award. Thus, hand-X 410 represents the “Nth” hand, such as the tenth hand in an embodiment where the player benefit is awarded every 10 hands. The number of hands in which to trigger the player benefit may be fixed (e.g., every 10 hands), random (e.g., a random number of plays to reach is presented to the player), etc.

In one embodiment, the player benefit is a payout modifier, such as the 5× multiplier 412 that may be presented anywhere desired. The multiplier 412 or other modifier may be applied to any payout occurring as a result of playing hand-X 410, or applied to all payouts occurring on one, more, or all of the hands between the first hand-A 400 and the triggering hand-X 410, or a future payout(s), or a past payout(s), etc. In another representative embodiment, the player benefit may be a Wild card(s) 414 provided in the hand-X 410 or a future hand(s). Or, a “richer” set of dealt cards and/or drawn cards may be provided for the triggering hand-X 410, such as adding face cards to the deck, or adding Royal Flush cards to the deck, or adding Wild cards to the deck, etc. These and/or other player benefits may be implemented, and those described herein are provided for purposes of illustration and example.

In some embodiments, the number or type of coins or other game items 402 collected over the collection period dictates, or at least affects, the benefit provided to the player. For example, the quantity, and/or type, and/or associated value, and/or other characteristics of the coins that are collected when the collection period ends may dictate or influence the value of the payout modifier, credit award, or other benefit provided to the player. For example, in a game item quantity embodiment, if the collection period is seven played poker hands, then the quantity of coins or other game items collected during those seven poker hands determines or helps to determine a modifier value (e.g. multiplier), or a number of Wild cards issued, or a number of free hands to play, etc. One embodiment would be that upon expiration of the collection period (e.g. a number of hands has been played, or a time has elapsed, or a triggering event occurred, etc.), collecting five coins during that collection period would result in a 5× multiplier being applied, where collecting eight coins during that collection period would result in an 8× multiplier being applied, etc. Analogously, another embodiment would be that upon expiration of the collection period, collecting five coins during that collection period would result in five Wild cards being issued, such as in a multi-play or other multi-hand game, where those five Wild cards may be distributed to random positions or in some systematic or otherwise defined manner. Similarly, the number of coins/game items collected over the collection period may correspond to free hands awarded. Thus, the number of items collected over the collection period may, in some embodiments, have an impact on the particular award or benefit provided to the player.

In other embodiments, the type of items collected may impact the award or benefit provided to the player. For example, some or all of the coins or other game items 402 may include indicia indicative of a value associated with that collected coin/game item 402, such as multiplier values, Wild cards available, credit values, free game counts, etc. In one particular example, some or all of the coins may include a multiplier value or other number, which are added, multiplied, or otherwise mathematically combined to form a collective multiplier. For example, if four game items 402 were collected over a collection period of, for example, five poker games, and the four game items respectively included indicia representing a 2×, 3×, 4×, and 10× multiplier, one embodiment may add those multipliers to arrive at a 19× multiplier to be used on hand-X 410 and/or other hand(s). In another embodiment, each of those multipliers associated with the game items may be used on different hands of a multi-hand poker game, or for different consecutively-played poker games (e.g. 2× for a next hand, 3× for the next hand after that, 4× for the next hand after that, and 10× for the next hand after that). In still other embodiments, the indicia on the collected game items 402 may instead or additionally include credit values, free hands, etc.

In another embodiment, the coins or other game items 402 may include indicia indicating that it is part of a set, that provides an award, payout modifier, Wild card(s) and/or other player benefit if a minimum threshold number of the parts to the set are collected during the collection period. For example, some of the coins may include indicia or other indications that the respective coin represents a portion of a set to obtain a progressive jackpot or other credit award, and if the requisite number of those coins are collected during the collection period, then the progressive jackpot or other credit award is provided. As another example, a particular multiplier or other payout modifier may be awarded to the player for use on the hand-x 410 and/or other hand(s) when three coins/game items 402 having that particular payout modifier identified thereon are collected during the collection period. Thus, some embodiments involve game items 406 that are of particular types that may be used in a manner dependent on the game item type(s) obtained.

In another embodiment, rather than triggering the player benefit on some number of played hands, the number of game items, e.g., coins 402, may instead be counted. The total number of coins, or a sum or other mathematical calculation of numbers presented on the coins, or other calculation based on the game items/coins 402 in the container 406 may be used as the trigger basis. For example, the player benefit may be provided when the number of coins 402 in the container 406 reaches a number, such as ten coins 402. In another example, the player benefit may be provided when the values associated with the coins 402 reaches a number, such as having multiplier values associated with each (or some) of the coins 402, and when the multiplier values of collected coins 402 reaches 10, then a 10× multiplier is awarded.

In one embodiment, a multiplier or other payout modifier, Wild card, enriched card, and/or other analogous benefit may be utilized on the hand-X 410 where the collection period ended. In other embodiments, the benefit may be utilized on one or more hands subsequent to hand-X 410. For example, in one embodiment, the coins 402 collected over a collection period may be doled out over the next number of hands, such as over the next number of hands corresponding to the number of coins 402 collected. As a more particular example, if 2×, 5× and 6×multipliers were obtained by collecting three coins 402 having those multiplier values over the collection period, then in one embodiment the 2×, 5×, and 6× multipliers will be individually applied to the next three poker hands played (e.g. hand-X 410 and the next two hands after that). Thus, the value of collected game items 402 may be applied at one time, or their value may be distributed over a plurality of the poker games or other gaming events.

Betting structure may be implemented as desired, whereby the cost to participate in the enhancement features described herein may be built into the normal cost per hand or per game, or may involve an additional single wager, or may involve an additional wager per hand played, etc. In one example, a wager to play a poker hand may be five credits, and an additional one credit is paid to participate in the enhancement features described herein, or an additional one credit per hand may be involved to participate in the enhancement features. Thus, a representative betting structure that could be used in the embodiment of FIG. 4 may be, for example, a 5+5 structure for a total of ten credits (e.g., five credits to play each hand, plus five credits to be eligible for the award enhancement feature for that hand). Any credit structure desired to accommodate the math to provide payouts at the desired rate may be employed.

In one embodiment, one player benefit may be that the coins 402 or other game items collected in the container 406 are distributed to various card positions of hand-X 410 and/or additional hands (e.g., future hands, or other hands in a multi-hand embodiment, etc.). In connection with such distribution, the coins may be converted to Wild cards, so that cards that are the recipient of the distribution will become Wild cards (with or without multipliers associated therewith). In other embodiments, the player benefit may be a plurality of Wild cards (with or without multipliers associated therewith) that randomly materialize on the card play area to replace one or more particular cards with Wild cards. These and/or other manners of adding Wild functionality to the poker game cards, which may be referred to herein as “spray wilds,” may be implemented.

An embodiment such as that of FIG. 4 therefore employs sub-symbols such as depictions of coins, where the issued coins are collected in a coin container, and every X hands (e.g., every 10 hands) the coins provide multipliers, spray wilds, both multipliers and spray wilds, etc. A 5+5 betting structure could be used, for example. The coins or other game items could come out of the container or other collection area in the form of Wild cards/functionality, multipliers, or both. In one embodiment, the coins convert to Wild cards/functionality on a 1:1 basis (i.e. each coin is converted to a separate Wild card), where in other embodiments it is not on a 1:1 basis and may provide a single Wild card/functionality and/or multiplier (and/or other player benefit), or some quantity between one and where a 1:1 correspondence would occur.

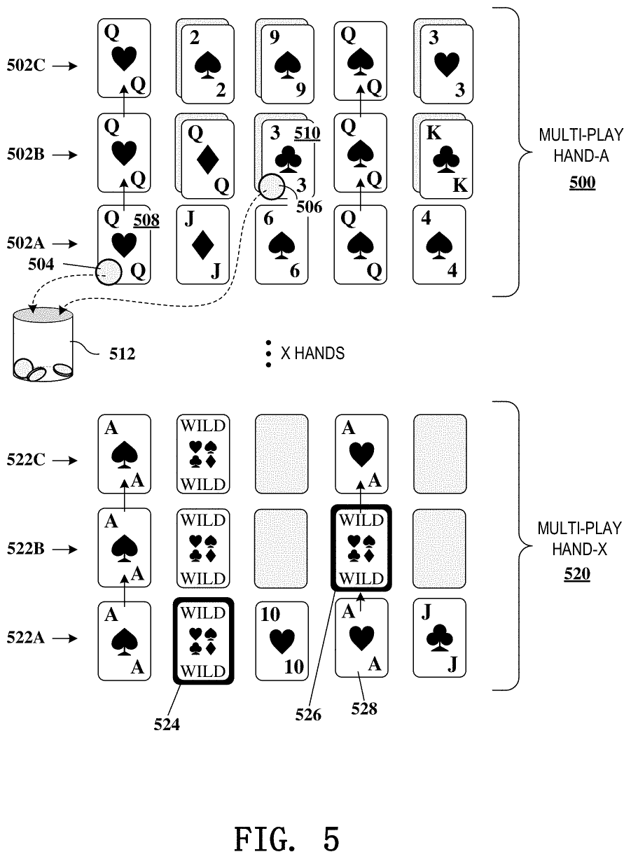

FIG. 5 depicts a representative example of a multi-hand draw poker game employing the player award features described herein. A multi-play hand-A 500 is played, which includes an initial deal of a hand 502A, and two more (in this example) hands 502B, 502C. In one embodiment, cards held in the initial hand 502A are replicated into corresponding card positions of other hands 502B, 502C (although the cards could be replicated into any of the card positions of the other hands 502B, 502C). After cards are drawn, into the non-held card positions, final hands result for each of the hands 502A, 502B, 502C.

The example of FIG. 5 operates substantially the same as that of FIG. 4, the exception that multiple hands are played concurrently. Thus, a first multi-play hand-A 500 of poker is dealt, which is assumed to be a triple-play (i.e. three concurrently-played hands) 5-card draw poker game for purposes of this example. In this example, the game item could again be represented by coins 504, 506 that in this example are randomly presented in connection with cards 508, 510 respectively, which are accumulated in the container 512. However, any manner of providing trackable, randomly-provided items, counts, etc. may be utilized.

In one embodiment, every ten hands (or however many hands desired), the coins in the container 512 are used as the basis for providing an award. Thus, multi-play hand-X 520 represents the “Xth” hand, such as the tenth hand in an embodiment where the player benefit is awarded every 10 hands. The number of hands in which to trigger the player benefit may be fixed (e.g., every 10 hands), random (e.g., a random number of plays to reach is presented to the player), etc.

In one embodiment, the player benefit is a payout modifier, such as a multiplier, Wild function, etc. In one embodiment, the number of coins collected during the played hands between the first hand 500 and the tenth (or other number) hand 520 may come out of the container 512, convert to Wild cards, and get distributed on hand-X 520, the next hand, other future hand(s), etc. In the illustrated embodiment, it is assumed that hand 520 receives a Wild card 524, 526 as a result of the coins 504, 506 coming from the container 512 and being distributed randomly (or systematically, or according to a predefined rule in other embodiments) about the multi-play hand-X 520. As the present example assumes a draw poker game, the Wild card 524 dealt to the first hand 522A may be held into corresponding positions in hands 522B, 522C as shown in FIG. 5.

In one embodiment, distributed Wild cards 524, 526 may be positioned with the initially dealt hand 522A, where in other embodiments they may be associated with one or more of the other hands 522B, 522C. Where a Wild card 524, 526 is positioned in a hand where a card 528 from hand 522A has already been or might be held and replicated into the other hands 522B, 522C, various embodiments may treat the replication and enhanced card(s) differently. For example, the replicated card 528 may override the enhanced card 526. In another embodiment, the enhanced card 526 may override the replicated card 528, as depicted in the example of multi-play hand-X 520 of FIG. 5. In still other embodiments, the “better” of the replicated card 528 and the enhanced card 526 may be used. In other embodiments, the enhanced card 526 is guaranteed to be as least as favorable as the replicated card 528, whereby the enhanced card 526 is always used (e.g., if the enhanced card is a Wild card, it also includes any card that could be replicated, and therefore the Wild card 526 will be used rather than the replicated card 528). These and other rules may be applied for card positions involving both a potentially replicated card and an enhanced card.

The Wild cards 524, 526 may be applied to hand-X 520, and/or applied to one or more hands following hand-X-520, and/or “re-applied” to one or more hands that already occurred to create a new or updated result of a past hand(s), etc. In an alternative embodiment, rather than Wild cards being distributed into the hand 520, it could instead be other awards, or award modifiers. For example, multipliers may be associated with one or more of the Wild cards to provide multiplier-Wild functionality. In another example, multipliers may be provided to be applied to payouts occurring on the hands 522A, 522B, 522C. In one embodiment, if multiple multipliers are provided on the same one of the hands 522A, 522B, 522C, an accumulated effect may be provided, such as adding or multiplying the various multipliers to arrive at a higher multiplier value. Alternatively, a “richer” set of dealt cards and/or drawn cards may be provided for the triggering hand-X 520 as a result of receiving the benefit. These and/or other player benefits may be implemented, and those described herein are provided for purposes of illustration and example.

In another embodiment, rather than triggering the player benefit on some number of played hands, the number of game items, e.g., coins 504, 506, may instead be counted. The total number of coins, or a sum or other mathematical calculation of numbers presented on the coins, or other calculation based on the game items/coins 504, 506 in the container 512 may be used as the trigger basis. For example, the player benefit may be provided when the number of coins 504, 506 in the container 512 reaches a number, such as five coins.

Additionally, all embodiments described in connection with FIG. 4 are also applicable to the multi-hand embodiment of FIG. 5.

In one embodiment, one player benefit may be that the coins 504, 506 or other game items collected in the container 512 are distributed to various card positions of hand-X 520 and/or additional hands (e.g., future hands, or other hands in a multi-hand embodiment, etc.). In connection with such distribution, the coins may be converted to Wild cards, so that cards that are the recipient of the distribution will become Wild cards (with or without multipliers associated therewith). In other embodiments, the player benefit may be a plurality of Wild cards (with or without multipliers associated therewith) that randomly materialize on the card play area to replace one or more particular cards with Wild cards.

An embodiment such as that of FIG. 5 therefore employs sub-symbols such as depictions of coins, where the issued coins are collected in a coin container, and every X hands (e.g., every 10 hands) the coins provide multipliers, spray wilds, multipliers, combinations of multipliers, spray wilds and multipliers, etc. A 5+5 betting structure such as described above could be used, for example. The coins or other game items could come out of the container or other collection area in the form of Wild cards/functionality, multipliers, or both. In one embodiment, the coins convert to Wild cards/functionality on a 1:1 basis (i.e. each coin is converted to a separate Wild card), where in other embodiments it is not on a 1:1 basis and may provide a single Wild card/functionality and/or multiplier (and/or other player benefit), or some quantity between one and where a 1:1 correspondence would occur.

The card enhancement feature may continue for another X hands (e.g., start the count over for another ten hands).

Betting structure may be implemented as desired, whereby the cost to participate in the enhancement features described herein may be built into the normal cost per hand or per game, or may involve an additional single wager, or may involve an additional wager per hand played, etc. For example, in a triple-play version such as shown in FIG. 5, three hands are dealt, where the player would hold cards in one of those hands that would be replicated in the other hands. A representative betting structure may be, for example, a 5+5 structure for a total of thirty credits (e.g., five credits to play each of the three hands, plus five credits to be eligible for the player benefit features described herein for each of the three hands). However, the betting structure may be managed in any way desired, such as 5+1, 5+2,5+3, 5+4, 5+5, 5+45, etc.

Some embodiments may also be employed to determine whether an indication to provide a poker hand benefit(s) will be active (thereby enabling the poker hand benefit) or passive (not enabling the poker hand benefit). For example, the player may place additional wagers to activate card positions or card columns or hands, etc. If the sub-symbols or other indicators are randomly or otherwise provided in an activated card position or column, the indicator will be active, thereby enabling the game item to be collected. In such a case, there might be no additional general wager to be eligible for the disclosed features, but rather the additional wager(s) is to make eligible certain portions (subset or the entire set) of card positions in which received indicators activate the poker hand benefit features described herein.

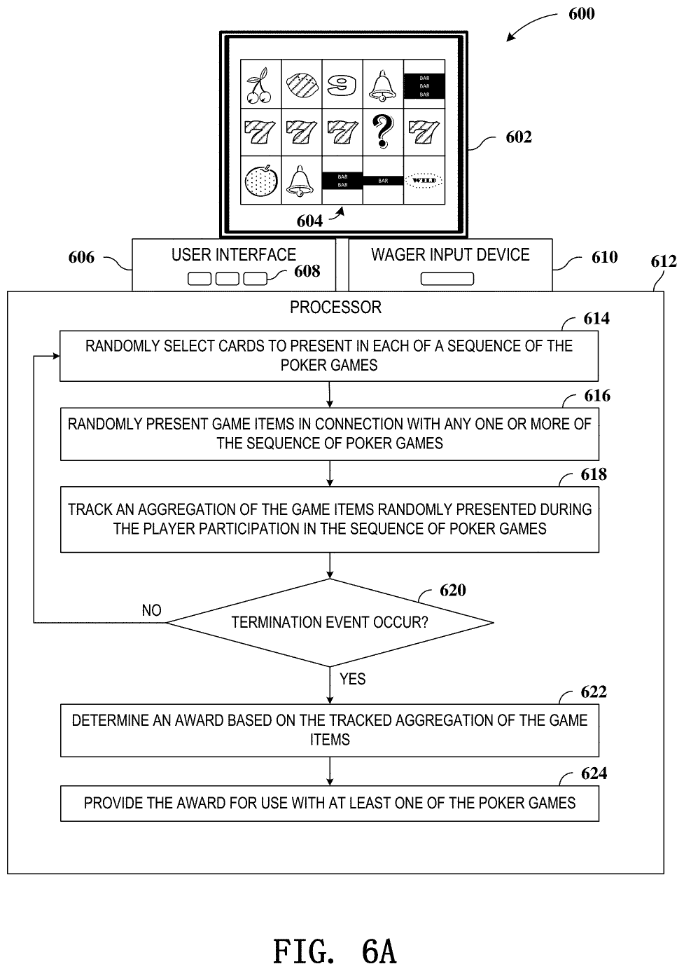

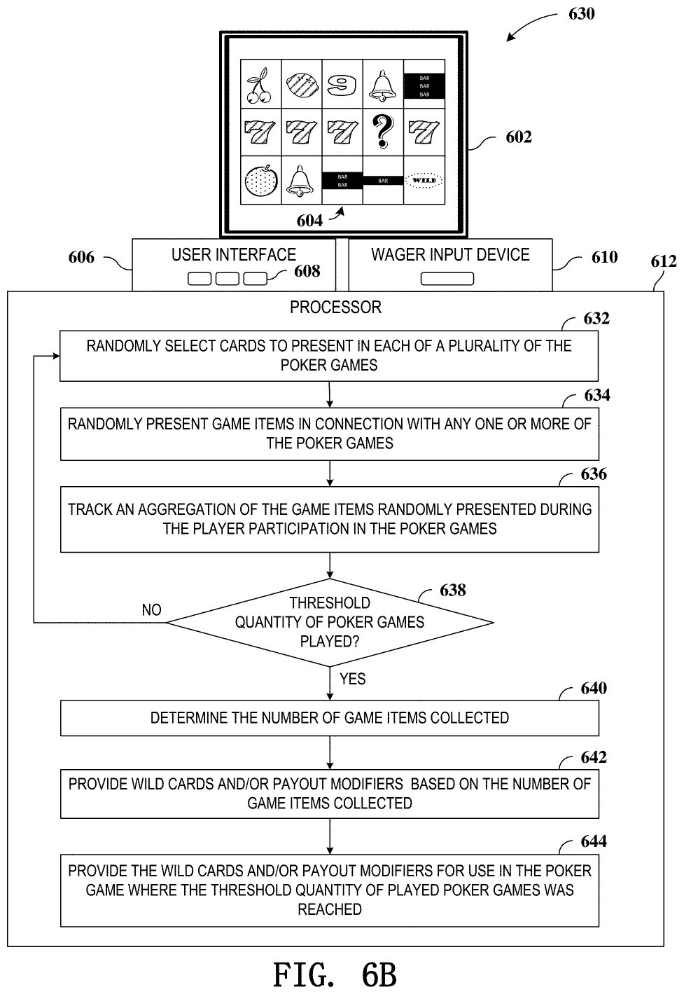

FIGS. 6A and 6B are diagrams of representative electronic poker devices for enhancing payments or otherwise providing awards for electronic poker games based on a collection of game play items. In the embodiment of FIG. 6A, a gaming device 600 for playing an electronic poker game is provided. The representative gaming device 600 includes at least a display(s) 602 presenting a single or multiple poker hands 604. A user interface 606 is provided that includes at least one user input 608 to enable a player to initiate and participate in poker hands 604 presented via the display 602. A wager input device 610 may be provided, which may be structured to identify and validate player assets and ultimately permit the player to play the poker games/hands when the player assets are provided. FIG. 6A is described in terms of either a single-hand poker game or multi-hand poker game.

A processor 612 is configured to, in one embodiment, randomly select 614 cards to present in each of a sequence of the poker games, and randomly present 616 game items in connection with any one or more of the sequence of poker games. The processor 612 is configured to track 618 an aggregation of the game items randomly presented during the player participation in the sequence of poker games, and monitor 620 monitor for a game item termination event during the sequence of poker games. In response to the game item termination event occurring in connection with a currently-played one of the sequence of poker games, the processor 612 is configured to determine 622 an award based on the tracked aggregation of the game items, and provide 624 the determined award for use with at least one of the poker games.

In the embodiment of FIG. 6B, a gaming apparatus 630 for playing an electronic poker game is provided. Utilizing like reference numbers to those of FIG. 6A where applicable, the representative gaming apparatus 630 includes at least a display(s) 602 presenting a single or multiple poker hands 604. A user interface 606 is provided that includes at least one user input 608 to enable a player to initiate and participate in poker hands 604 presented via the display 602. A wager input device 610 may be provided, which may be structured to identify and validate player assets and ultimately permit the player to play the poker game events when the player assets are provided.

The processor 612 is configured to, in one embodiment, randomly select 632 cards to present in each of a plurality of the poker games, and randomly present 634 game items in connection with any one or more of the poker games. The processor 612 is configured to track 636 an aggregation of the game items randomly presented during the player participation in the poker games, and monitor 638 for a threshold quantity of the poker games having been played. In response to the threshold quantity of the poker games having been played, the processor is configured to determine 640 a quantity of the game items that have been aggregated.

In one embodiment, the processor 612 is configured to provide 642 one or more Wild cards based on the number of game items that have been aggregated, and to provide 644 the Wild cards for use in the poker game in which the threshold quantity of the poker games has been reached. The Wild cards could instead or additionally be provided for use in one or more subsequent poker games.

In another embodiment, the processor 612 is configured to provide 642 one or more payout modifiers, such as multipliers, based on the number of game items that have been aggregated, and to provide 644 the resulting one or more payout modifiers for use in the poker game in which the threshold quantity of the poker games has been reached. The Wild cards could instead or additionally be provided for use in one or more subsequent poker games.

In still other embodiments, the processor 612 provides 642 both Wild cards and payout modifiers based on the number of game items collected, and provides 644 both the Wild cards and the payout modifiers for use in the current game and/or one or more subsequent poker games.

The principles described herein may be applied to other games, such as keno, bingo, etc. For example, in the context of keno, particular number positions (whether associated with positions of the player's identified numbers or not) may be randomly identified with a sub-symbol or otherwise. When the triggering event occurs, one or more of the players keno numbers may be converted to Wild functionality so that any of the randomly selected keno balls serve as a matching number. Alternatively or additionally, multipliers or other modifiers may be provided analogously. Similar examples apply to games such as bingo, where a bingo card position may be marked as wild, and the current and/or subsequent bingo games treat the marked position as a free space (similar to the middle position in many bingo games) These and other applications of the enhancement features described herein may be employed.

The foregoing description of the representative embodiments has been presented for the purposes of illustration and description. It is not intended to be exhaustive or to limit the invention to the precise form disclosed. Many modifications and variations are possible in light of the above teaching. For example, the present invention is equally applicable in electronic or mechanical gaming machines, and is also applicable to live table versions of gaming activities that are capable of being played in a table version (e.g., machines involving poker or card games that could be played via table games).

Some embodiments have been described above, and in addition, some specific details are shown for purposes of illustrating the inventive principles. However, numerous other arrangements may be devised in accordance with the inventive principles of this patent disclosure. Further, well known processes have not been described in detail in order not to obscure the invention. Thus, while the invention is described in conjunction with the specific embodiments illustrated in the drawings, it is not limited to these embodiments or drawings. Rather, the invention covers alternatives, modifications, and equivalents that come within the scope and spirit of the principles set out herein and/or in the appended claims.

What is claimed is:

1. A gaming apparatus for facilitating player participation in poker games, the gaming apparatus comprising:
a display;
a user interface configured to receive at least player input to facilitate player participation in the poker games;
a wager input device structured to identify and validate player assets, and to permit the player to participate in the poker games in which the player assets are provided;
a processor configured to:
randomly select cards to present in each of a sequence of the poker games;
randomly present game items in connection with any one or more of the sequence of poker games;
track an aggregation of the game items randomly presented during the player participation in the sequence of poker games;
monitor for a game item termination event during the sequence of poker games;
in response to the game item termination event occurring in connection with a currently-played one of the sequence of poker games, determine an award based on the tracked aggregation of the game items; and
provide the determined award for use with at least one of the poker games.

2. The gaming apparatus of claim 1, wherein the processor is configured to determine the award based on the tracked aggregation of the game items by determining a quantity of the game items that were presented during the player participation in the sequence of the poker games, and providing a Wild card for each of the determined quantity of the game items for use with the at least one of the poker games.

3. The gaming apparatus of claim 1, wherein the processor is configured to determine the award based on the tracked aggregation of the game items by determining a quantity of the game items that were presented during the player participation in the sequence of the poker games, and providing a Wild card for each of the determined quantity of the game items for use with the at least one of the poker games.

4. The gaming apparatus of claim 2, wherein the processor is configured to provide the determined award for use with at least one of the poker games by providing the determined award for use with a next consecutive one of the poker games following the sequence of poker games, and randomly distributing any of the provided Wild cards to card positions of the next consecutive one of the poker games following the sequence of poker games.

5. The gaming apparatus of claim 1, wherein the processor is configured to determine the award based on the tracked aggregation of the game items by determining a quantity of the game items that were presented during the player participation in the sequence of the poker games, and providing a payout multiplier having a multiplication quantity based on the determined quantity of the game items for use with the at least one of the poker games.

6. The gaming apparatus of claim 1, wherein the processor is configured to determine the award based on the tracked aggregation of the game items by identifying multiplier values on one or more of the tracked aggregation of the game items, and providing a payout multiplier having a multiplication quantity based on a collective value of the identified multiplier values.

7. The gaming apparatus of claim 1, wherein the processor is configured to monitor for the game item termination event by monitoring for completion of the player participation in a threshold number of the poker games constituting the sequence of the poker games.

8. The gaming apparatus of claim 1, wherein the processor is configured to monitor for the game item termination event by monitoring for a threshold number of the game items being collected.

9. The gaming apparatus of claim 1, wherein the processor is configured to provide the determined award for use with at least one of the poker games by providing the determined award for use with the currently-played one of the sequence of poker games.

10. The gaming apparatus of claim 1, wherein the processor is configured to provide the determined award for use with at least one of the poker games by providing the determined award for use with a next consecutive one of the poker games following the sequence of poker games.

11. The gaming apparatus of claim 1, wherein the processor is configured to provide the determined award for use with at least one of the poker games by providing the determined award for use with one or more subsequent ones of the poker games following the sequence of poker games.

12. The gaming apparatus of claim 1, wherein the processor is configured to present the tracked aggregation of the game items to enable the player to perceive progress of the tracked aggregation of the game items.

13. The gaming apparatus of claim 1, wherein the processor is configured to randomly present the game items by randomly displaying, via the display, sub-symbols in connection with the randomly selected cards of the sequence of the poker games.

14. The gaming apparatus of claim 1, wherein the processor is configured to facilitate the player's participation in a plurality of the sequences of the poker games, and to provide respective ones of the determined awards on each of the plurality of the sequences of the poker games.

15. A gaming apparatus for facilitating player participation in poker games, the gaming apparatus comprising:
a display;
a user interface configured to receive at least player input to facilitate player participation in the poker games;
a wager input device structured to identify and validate player assets, and to permit the player to participate in the poker games in which the player assets are provided;
a processor configured to:
randomly select cards to present in each of a plurality of the poker games;
randomly present game items in connection with any one or more of the poker games;
track an aggregation of the game items randomly presented during the player participation in the poker games;
monitor for a threshold quantity of the poker games having been played;
in response to the threshold quantity of the poker games having been played, determine a quantity of the game items that have been aggregated;
provide one or more Wild cards based on the determined quantity of the game items that have been aggregated;
provide the one or more Wild cards for use in the poker game in which the threshold quantity of the poker games has been reached.

16. The gaming apparatus of claim 15, wherein the processor is configured to provide the one or more Wild cards by providing one of the Wild cards for each of the determined quantity of the game items that have been aggregated.

17. The gaming apparatus of claim 15, wherein the processor is further configured to provide one or more payout modifiers for use in the poker game in which the threshold quantity of the poker games has been reached, in response to the threshold quantity of the poker games having been played.

18. A gaming apparatus for facilitating player participation in poker games, the gaming apparatus comprising:
a display;
a user interface configured to receive at least player input to facilitate player participation in the poker games;
a wager input device structured to identify and validate player assets, and to permit the player to participate in the poker games in which the player assets are provided;
a processor configured to:
randomly select cards to present in each of a plurality of the poker games;
randomly present game items in connection with any one or more of the poker games;
track an aggregation of the game items randomly presented during the player participation in the poker games;
monitor for a threshold quantity of the poker games having been played;
in response to the threshold quantity of the poker games having been played, determine a quantity of the game items that have been aggregated;
provide one or more payout modifiers based on the determined quantity of the game items that have been aggregated;
provide the one or more payout modifiers for use in the poker game in which the threshold quantity of the poker games has been reached.

19. The gaming apparatus of claim 18, wherein the processor is configured to provide the one or more payout modifiers by providing a multiplier having a multiplier value equivalent to the determined quantity of the game items that have been aggregated.

20. The gaming apparatus of claim 18, wherein the processor is further configured to provide one or more Wild cards for use in the poker game in which the threshold quantity of the poker games has been reached, in response to the threshold quantity of the poker games having been played.
